(19) United States
(12) Patent Application Publication
(10) Pub. No.: US 2006/0207929 A1
(43) Pub. Date: Sep. 21, 2006

(54) Fuel filter for a motor vehicle

(76) Inventors: Florian Epping, Usingen (DE); Holger Wehner, Bad Soden-Altenhain (DE)

Correspondence Address: MAYER, BROWN, ROWE & MAW LLP, P.O. BOX 2828, CHICAGO, IL, 60690-2828, US

(21) Appl. No.: 10/548,910

(22) PCT Filed: Mar. 5, 2004
(86) PCT No.: PCT/EP04/02267

§ 371 Date: Sep. 13, 2005

(30) Foreign Application Priority Data
Apr. 4, 2003 (DE) 103155066

(51) Int. Cl. B01D 29/00

(52) U.S. Cl. 210/455; 210/483; 210/485

(57) ABSTRACT

The invention relates to a fuel filter for a motor vehicle. According to the invention, two cover disks (5, 6) retainingi a filter tissue (7) are produced as one piece with one half of a support cage (8) of the filter tissue (7) each. The cover disks (5, 6) have an identical structure and can be fitted together. This permits the fuel filter to be produced in a particularly cost-effective manner.

The invention relates to a fuel filter for a motor vehicle, having a filter cloth which is arranged in a filter housing and is retained between two cover disks, having a support cage radially supporting the filter cloth and having connecting pieces for connecting lines.

Fuel filters of this type are used in motor vehicles today, in a forward-flow line guided between a fuel pump and an internal combustion engine, and are known in practice. In the case of these fuel filters, the support body is fitted loosely between the cover disks and the seals are mounted in a form-fitting manner in the cover disks. The seals separate a clean side from a dirty side of the fuel filter.

A disadvantage of the known fuel filter is that it has a large number of individual parts which are complicated to fit. The high number of individual parts therefore results in a cost-intensive manufacturing of the fuel filter.

The invention is based on the problem of designing a fuel filter of the type mentioned at the beginning in such a manner that it can be manufactured particularly cost-effectively.

This problem is solved according to the invention in that at least one of the cover disks is manufactured integrally with at least part of the support cage, and in that that end of the support cage which faces away from the cover disk is manufactured with the other cover disk and/or with a component connected integrally to the other cover disk.

By means of this design, the support cage is connected integrally to the cover disk. The fuel filter according to the invention therefore does not require a support cage which has to be manufactured and fitted separately. This enables the fuel filter according to the invention to be manufactured particularly cost-effectively. The integral manufacturing of the cover disk and of the support cage also ensures that the cover disks are reliably aligned with respect to the filter cloth supported by the support ring. This avoids fuel being able to flow past the filter cloth from the dirty side to the clean side.

The fuel filter according to the invention can be composed of identical parts if the cover disks have identical shapes and dimensions. The use of identical parts permits a particularly cost-effective manufacturing of the fuel filter according to the invention.

The fuel filter according to the invention turns out to be particularly simple structurally if the cover disks are each connected to half of the support cage.

According to another advantageous development of the invention, the cover disks can be fitted together in a simple manner if the support cage has struts which are arranged essentially vertically on the cover disk and are spaced apart from one another by more than their own width, and rings which are arranged parallel to the cover disk, and if the struts are guided radially on the inside or radially on the outside past the rings and protrude over the ring furthest away from the cover disk.

According to another advantageous development of the invention, the alignment of the cover disks and of the support cage with respect to one another is simplified if the struts have guide pins at their free ends.

The installation of the fuel filter according to the invention is further simplified if the free ends of the struts have means corresponding with the opposite component, for clamping or latching them in place.

According to another advantageous development of the invention, the guiding of the fuel requires a particularly low structural outlay if at least one of the cover disks has a central recess, if one of the connecting pieces projects into the central recess, and if a sealing lip is arranged on the connecting piece or on the cover disk and bears against the opposite component.

The installation of the fuel filter according to the invention is further simplified if the central recess has an introductory slope for the connecting piece or a closure bolt of the housing.

According to another advantageous development of the invention, the sealing of the filter cloth requires a particularly low outlay if the filter cloth is welded to the cover disks. The filter cloth and the cover disks are preferably manufactured by a butt-welding process with heat reflectors. By means of the exact alignment of the cover disks and therefore of the support ring in relation to the filter cloth, it is ensured that the filter cloth reliably bears against the cover disks before butt-welding with heat reflectors. The seal tightness is therefore reliably ensured after the butt-welding with heat reflectors.

The invention permits numerous embodiments. To further clarify its basic principle, one of these is illustrated in the drawing and is described below. In the drawing

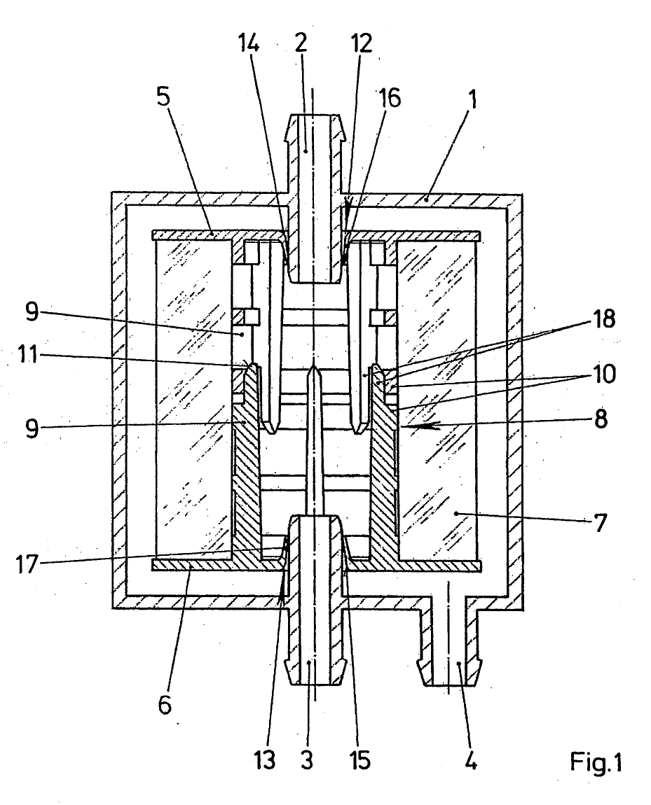

FIG. 1 shows a sectional illustration through a fuel filter according to the invention,

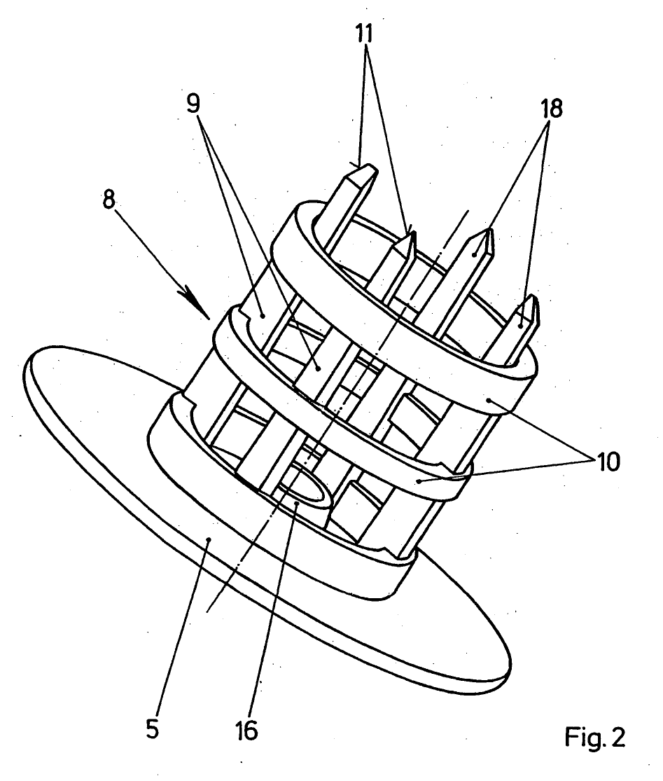

FIG. 2 shows an enlarged perspective illustration of a cover disk of the fuel filter from FIG. 1.

FIG. 1 shows a fuel filter in a longitudinal section with a housing 1 and three connecting pieces 2-4. Arranged within the housing 1 is a filter cloth 7 retained between two cover disks 5, 6. The filter cloth 7 is supported radially on the inside by a support cage 8. The support cage 8 has struts 9 protruding at right angles from the cover disks 5, 6 and rings 10 connected to the struts 9. The cover disks 5, 6 are in each case manufactured integrally with one half of the support cage 8 and are welded to the filter cloth 9, for example, in the butt-welding process with heat reflectors. The struts 9 protrude in each case over the ring 10, which is furthest away from the particular cover disk 5, 6 and has guide pins 18, and are connected frictionally to the next ring 10 of the opposite cover disk 5, 6. The halves of the support cage 8 and therefore the cover disks 5, 6 are therefore connected frictionally to one another. To simplify the installation, the free ends of the struts 9 have introductory slopes 11. Of course, the free ends of the struts 9 can have, in the region of the introductory slopes 11, radially resilient latching hooks (not illustrated) with which they engage behind the ring 10 of the opposite half of the support cage 8. The cover disks 5, 6 have an identical structure.

The cover disks 5, 6 each have a central recess 12, 13 with an introductory slope 14, 15 and a sealing lip 16, 17. The sealing lip 16, 17 is sealed off on the connecting pieces 2, 3 arranged centrally in the housing 1. The central connecting pieces 2, 3 are therefore connected in the housing 1

first of all to that region of the fuel filter which is arranged radially within the support cage 8. The third connecting piece 4 opens into the radially outer region bounded by the filter cloth 7 and forms an inlet of the fuel filter. Fuel flowing in via the third connecting piece 4 passes through the filter cloth 7 and then passes to the two central connecting pieces 2, 3. Cleaned fuel can be removed at the two central connecting pieces 2, 3. As a rule, a single, central connecting piece 2, 3 is sufficient for removing the cleaned fuel. In this case, one of the central connecting pieces 2, 3 can be designed as a leakproof closure bolt of the housing and can exclusively close the particular recess 12, 13 in the cover disk 5, 6. As an alternative, a pressure-limiting valve or pressure regulator can be fitted into the connecting piece 2, 3. The housing 1 of the fuel filter is illustrated diagrammatically in the drawing. Of course, the housing 1 can have further components, such as, for example, stops (not illustrated) for supporting the cover disks 5, 6.

FIG. 2 shows one of the cover disks 5 of the fuel filter from FIG. 1 in a perspective illustration. It can be seen here that the struts 9 are narrower than the intermediate spaces between the struts 9. The two identically constructed cover disks 5, 6 from FIG. 1 can therefore fit together.

1. A fuel filter for a motor vehicle, having a filter cloth which is arranged in a filter housing and is retained between two cover disks, having a support cage radially supporting the filter cloth and having connecting pieces for connecting lines, characterized in that at least one of the cover disks (5, 6) is manufactured integrally with at least part of the support cage (8), and in that that end of the support cage (8) which faces away from the cover disk (5, 6) is manufactured with the other cover disk (5, 6) and/or with a component connected integrally to the other cover disk (5, 6).

2. The fuel filter as claimed in claim 1, characterized in that the cover disks (5, 6) each have half of the support cage (8).

3. The fuel filter as claimed in claim 1 or 2, characterized in that the cover disks (5, 6) have identical shapes and dimensions.

4. The fuel filter as claimed in at least one of the preceding claims, characterized in that the support cage (8) has struts (9) which are arranged essentially vertically on the cover disk (5, 6) and are spaced apart from one another by more than their own width, and rings (10) which are arranged parallel to the cover disk (5, 6), and in that the struts (9) are guided radially on the inside or radially on the outside past the rings (10) and protrude over the ring (10) which is furthest away from the cover disk (5, 6).

5. The fuel filter as claimed in at least one of the preceding claims, characterized in that the struts (9) have guide pins (18) at their free ends.

6. The fuel filter as claimed in at least one of the preceding claims, characterized in that the free ends of the struts (9) have means corresponding with the opposite component, for clamping or latching them in place.

7. The fuel filter as claimed in at least one of the preceding claims, characterized in that at least one of the cover disks (5, 6) has a central recess (12, 13), in that one of the connecting pieces (2, 3) projects into the central recess (12, 13), and in that a sealing lip (16, 17) is arranged on the connecting piece (2, 3) or the cover disk (5, 6) and bears against the opposite component.

8. The fuel filter as claimed in at least one of the preceding claims, characterized in that the central recess (12, 13) has an introductory slope (14, 15) for the connecting piece (2-4) or closure bolt of the housing (1).

9. The fuel filter as claimed in at least one of the preceding claims, characterized in that the filter cloth (7) is welded to the cover disks (5, 6).
